(19) United States
(12) Patent Application Publication
(10) Pub. No.: US 2010/0162710 A1
(43) Pub. Date: Jul. 1, 2010

(54) Pre-Mix Combustion System for a Gas Turbine and Method of Operating of operating the same

(75) Inventors: Peter Senior, Levittown, PA (US); Nigel Wilbraham, West Midlands (GB)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, Munchen (DE)

(21) Appl. No.: 12/226,552

(22) PCT Filed: Apr. 12, 2007
(86) PCT No.: PCT/EP2007/053546

§ 371 Date: Mar. 19, 2010

(30) Foreign Application Priority Data
Apr. 21, 2006 (EP) 06008313.6

(51) Int. Cl. F02C 7/00; F02C 7/22

(52) U.S. Cl. 60/737; 60/746

(57) ABSTRACT

The invention is related to a gas turbine pre-mix combustion system comprising: at least one combustor with a combustor wall partly surrounding a combustion zone; at least one mixing duct including an air passage leading to an outlet opening being open towards the combustion zone; and one or more fuel injection openings leading into the air passage and connecting it to one or more fuel supply passages so as to allow the injection of fuel into air flowing through the air passage. The locations of at least two outlet openings or at least two sections of a single outlet opening and the orientation of downstream sections of the respective air passages or air passage are chosen such that fuel/air mixtures flowing out of the outlet openings or said sections of a single outlet opening show opposed flow paths so as to impinge on each other in the combustion zone.

### CROSS REFERENCE TO RELATED APPLICATIONS

This application is the US National Stage of International Application No. PCT/EP2007/053546, filed Apr. 12, 2007 and claims the benefit thereof. The International Application claims the benefits of European application No. 06008313.6 filed Apr. 21, 2006, both of the applications are incorporated by reference herein in their entirety.

### FIELD OF THE INVENTION

The present invention relates to a pre-mix combustion system which is to be used in a gas turbine engine and to a method of operating such a pre-mix combustion system.

### BACKGROUND OF THE INVENTION

Gas turbine engines include, in general, a compressor section, a combustor section comprising one or more combustors, and a turbine section with one or more turbine stages. In operation, a fuel is burned in the combustor to produce hot pressurised exhaust gases which are then fed to a turbine stage where they, while expanding and cooling, transfer momentum to the turbine stages thereby imposing a rotational movement on a rotor extending through the gas turbine engine. Mechanical power of the turbine rotor, resulting from the rotational movement, can then be used to drive a generator for producing electrical power or to drive a machine.

However, burning the fuel leads to a number of undesired pollutants in the exhaust gases which can cause damage to the environment. Therefore, considerable effort is made to keep the pollutants at as low a level as possible. One kind of pollutant is nitrous oxide (NOₓ). The rate of formation of nitrous oxide depends exponentially on the temperature of the combustion flame. Another kind of pollutant, hydrocarbons, can result if a part of the fuel is not, or only partially, burned in the combustor.

There are two main measures in the state of the art by which the reduction of nitrous oxide pollutant is achievable. The first is to use a lean stoichiometry, e.g. a fuel/air mixture with a low fuel fraction. The relatively small fraction of fuel leads to a combustion flame with a low temperature and, thus, a low rate of nitrous oxide formation. The second measure is to provide a thorough mixing of the fuel and air before the combustion takes place. The better the mixing is the more uniformly distributed is the fuel in the combustion zone. This helps to prevent hot spots in the combustion zone which would arise from relative local maxima in the fuel/air mixing ratio, i.e. zones with high fuel/air mixing ratio compared to the average fuel/air mixing ratio in the combustor.

Modern gas turbine combustors use the concept of pre-mixing air and fuel in lean stoichiometry before the combustion of the fuel/air mixture. Usually the pre-mixing takes place by injecting fuel into an air stream in a swirling zone of a combustor which is located upstream from the combustion zone. The swirling leads to a mixing of fuel and air before the mixture enters the combustion zone. However, due to the lean stoichiometry mixing ratio the combustor becomes more prone to oscillations in the combustion system, and in particular in the flame. It is therefore an issue not only to provide a thorough mixing of fuel and air but also to provide flame stabilisation by the swirl. Both the stabilisation by the swirling flow and the mixing strongly depend on aerodynamics but the state of the art swirl-flow based solutions for stabilising and mixing do not decouple these effects so that neither can be fully optimised. This issue becomes more acute with dual-fuel burners using liquid fuels in which the droplet trajectories induced by the air flow can result in an impact of droplets with the walls with consequent coking, overheating and smoke emissions.

As already mentioned, the state of the art turbine burners usually achieve both mixing and flame stabilisation by a swirl flow. Strong mixing effects are produced by streamline curvatures in turbulent swirling flows leading to higher turbulence generation. Unfortunately, the same effect causes high internal friction losses as well as wall friction losses leading to significant pressure losses which effect machine efficiency. Hence, the optimum for mixing is to balance the strength of the swirl between mixing and pressure loss. Picking a swirl value which just causes a recirculation bubble to form remote from any walls in the centre of the swirling flow also permits flame stabilisation. An example of a combustor using this kind of stabilisation is disclosed in US2003/0010032A1. The type of choice for the swirl value, however, leaves a recirculation zone which is more sensitive to changes in flow condition, which can, if not carefully controlled, lead to combustion dynamics. Furthermore, achievable flame stretch rates are lower than for the solutions described in the next paragraph. The stretch rates give a measure for the gradient of the aerodynamic strain throughout the flame which effects the heat release. A high stretch rate reduces local flame temperature overshoots and, thus, the NOₓ production. In the context of low emissions, the lower flame stretch rates achievable with the burner disclosed in US2003/0010032A1 are normally traded off against the lower pressure loss permitting sequential cooling of the combustor with the burner air prior to fuel mixing within the same overall combustion system pressure loss, thus reducing NOₓ by using a leaner flame.

On the other hand, strong flame stabilisation is achieved by regions of reverse flow creating a high swirl and the higher the swirl, the more (hot) flow is returned from the combustion region downstream to ignite the oncoming fuel/air mixture. Furthermore, extremely high rates of swirl are known to stretch the flame formed in such zones which reduces the emissions of NOₓ. However, there is an associated penalty in the form of pressure losses and an enhanced potential for the flame to amplify disturbances in the fuel/air ratio which can, if not carefully controlled, lead to combustion dynamics. Very high rates of swirl also tend to extend the hot reverse flow zones which may then possibly subject the combustor to the thermal issues. An example of such a type of combustor is, e.g., disclosed in U.S. Pat. No. 6,532,726 B2. A problem which may arise in such a combustion system is the high centrifuging effect on liquid fuel droplets which causes either a compromise on NOₓ performance or a droplet wall deposition.

A further alternative to the above involves the use of catalysts for pre-burning the mixture, raising the mixture's temperature to the point where only mild or no recirculation is required to stabilise the flame. An example of catalytic pre-burning is described, e.g., in EP 1 510 761 A 1. Due to the propensity of the known practical catalysts to deactivate already at moderate temperatures this leads to the need for narrow cooled catalyst channels to keep the pre-burned reaction under control. Such channels are susceptible to the surface impact problems of liquid fuels, not to mention their sensitivity to trace contaminations in such fuels. Furthermore, such narrow channels are expensive to manufacture within the tolerances necessary for building balanced systems of multiple burners giving even temperatures around the turbine entry annulus.

A method and an apparatus for flame stabilisation in pre-mix-burners for installations with atmospheric combustion, i.e. combustion in an atmospheric pressure range, are described in U.S. Pat. No. 5,685,705. A wall of a pre-mixing burner has a plurality of radial openings located on at least one plane perpendicular to the flow direction of the burner's main fuel/air mixture. A gaseous medium of supplemental fuel or a supplemental fuel/air mixture is introduced into the main fuel/air mixture and directed traverse to the flow of the main fuel air mixture.

In many of the mentioned technologies the introduction of pilot fuel into the combustion zone to support off design operation is severely compromised either by the necessity to introduce it somewhere in the same flow path as the main fuel in order to reach the flame stabilisation zone or by high NOₓ generated when injecting pilot fuel directly into other regions of the combustor.

### SUMMARY OF THE INVENTION

It is therefore an objective of the present invention to provide a pre-mix combustion system and a method of operating a pre-mix combustion system which allows the decoupling of the two desired effects of mixing and stabilisation.

The objective is solved by a method of operating a pre-mix combustion system, in particular a gas turbine combustion system, and by a pre-mix combustion system, as claimed in the independent claims. The depending claims define further developments of the present invention.

In the inventive method of operating a pre-mix combustion system, in particular of operating a gas turbine combustion system, a main fuel is mixed with main air to form a main fuel/air mixture, and at least two streams, or at least two sections of a single stream, of the main fuel/air mixture are introduced into a combustion zone in opposed flow paths, so as to impinge on each other. In addition to the main fuel/air mixture which keeps the combustion upright, supplemental fuel or main fuel/air mixtures could be introduced into the flame, e.g. pilot fuel.

By performing the mixing in opposed flow paths (which may or may not have some swirl forming means or other device to enhance turbulent mixing) followed by mutual impact of the main fuel/air mixtures flowing along these flow paths offers the possibility of forming a highly stretched flame with strong stabilisation properties and NOₓ suppression. Since the impact zone, which stabilises the flame, is in “mid-air” there is a much lower combustor surface area exposed to hot re-circulated exhaust gas, and a high stretch rate can be achieved without compromising mixing. The form and location of the impact zone can be varied independently from the mixing parameters determining the mixing throughout the mixing paths to achieve optimal performance for both objectives.

In addition, since the inventive method allows the decoupling of the pressure loss due to the mixing from the stabilisation, it becomes possible to have a design which has the potential for sequential use of cooling air as well as highly strained flame zone—e.g. combining both features which lead to extremely low NOₓ-emissions. The strain ratio of a flame indicates, in a laminar stream, the velocity ratio of neighbouring flow paths. A high strain assures a thorough mixing of fuel and air in the combustion zone.

By introducing the main fuel/air mixtures into the combustion zone so as to impinge on each other off-centre, i.e. offsetting the axes of the incoming mixing paths slightly relative to each other, it will become possible to have a partially swirled stabilisation zone whilst maintaining zero swirl in the mixing path. Curved inlet paths could also be used to provide streamline curvature without invoking swirl.

With the inventive method, the ability to vary mixing streamline curvature without impinging on other parts of the design means that the mixing path can be tailored to both gaseous and liquid fuels, so that both are fully mixed (including evaporation) and thus perform in very similar ways in the stabilisation zone, which is rarely, if ever, the case with state of the art dual-fuel technologies. This is distinctly advantageous for the control of any combustion dynamics issues as well as for robustness of the range of fuels and practical variations in their composition.

In an advantageous embodiment of the inventive method the streams or the sections of the single stream of the main fuel/air mixture are introduced at an angle of at least 90° with respect to a main flow direction of the main fuel/air mixture in the combustion chamber. In particular, if the angle is 90°, the positioning of the flame stabilisation zone is at a right angle to streamwise disturbances linked to streamwise combustor acoustic (standing wave) modes. Therefore, the sensitivity to streamwise disturbances is strongly reduced.

In a further advantageous development, a fraction of the main fuel/air mixture, which is not flowing in the main flow direction of the main fuel/air mixture in the combustion zone, is re-circulated into the combustion zone. By this measure a flow from the impingement zone away from the turbine will be re-circulated around the head end of the combustor and back into the flame. This recirculation leads to lower NOₓ emissions due to the so-called reburn phenomenon. Until the present invention, practical implementation of such flue gas recirculation (FGR) has proved to be difficult to accomplish in a simple combustion stage. FGR also strongly enhances flame stability and some research indicates that it may help to control acoustic pulsations. In a special implementation of the inventive method, additional or supplemental fuel and/or air is introduced into the re-circulated main fuel/air mixture before it re-enters the flame.

In another advantageous development of the inventive method, a number of streams of the main fuel/air mixture are introduced into the combustion zone. Groups of streams are formed from the number of streams. In each group, at least two streams are introduced into the combustion zone in such a way as to impinge on each other in a respective impingement zone. The impingement zones of the different groups of streams are staggered in the combustion zone. The staggering of the impingement zones, or impact zones, in particular in the axial direction of the combustor axis, could smear the heat release and reduce the coupling of the flame with longitudinal modes of the combustion space.

An inventive pre-mix combustion system, which may, in particular, be a gas turbine combustion system, comprises at least one combustor with a combustor wall which partly surrounds a combustion zone. It further comprises at least one main mixing duct including a main air passage which leads to an outlet opening being open towards the combustion zone. One or more fuel injection openings lead into the air passage and connect it to one or more main fuel supply passages so as to allow the injection of fuel into air flowing through the main air passages. In the inventive pre-mix combustion system, the location of at least two outlet openings or at least two sections of a single outlet opening and the orientation of downstream sections of the respective main air passages or main air passage are chosen such that fuel/air mixtures flowing out of the outlet openings or said sections of a single outlet opening show opposed flow paths so as to impinge on each other in the combustion zone. With the inventive pre-mix combustion system, the inventive method can be performed. Therefore, the advantages already discussed with respect to the inventive method can be realised with the inventive pre-mix combustion system.

Since the zone of the highly strained flame can be made directly accessible from the end of the combustor—or even from the sides if the impingement zone is arranged in a bounded “pot”—in the inventive pre-mix combustion system, one or more pilot streams can be added completely separately from the main fuel/air mixture streams allowing design freedom to tailor fuel/air ratios and mixedness without reference to the main aerodynamics, but still making use of the high strain aerodynamics of the impingement zone in order to get the NOₓ advantages.

In particular, the location of the outlet openings or said sections of a single outlet opening and the orientation of the respective downstream sections can be chosen such that the flow path of the main fuel/air mixtures flowing out of the outlet openings or said sections of a single outlet opening are offset relative to each other so that the impingement of the main fuel/air mixtures in the combustion zone is off centre. By the off centre impingement it becomes possible to have a partially swirled stabilising zone while maintaining zero swirl in the mixing path. Curved inlet paths could also be used to improve streamline curvature without invoking swirl.

In a further development of the inventive pre-mix combustion system, the location of the outlet openings or said sections of a single outlet opening and the orientation of the downstream sections are chosen such that at least one of the opposed flow paths includes an angle, with respect to a main flow direction in the combustor, which is greater than 45°, in particular, greater than 80°, e.g. 90°. Preferably, the location of the outlet openings or said sections of a single outlet opening and the orientation of the downstream sections are symmetric with respect to the main flow direction, i.e. both flow paths include an angle of the same absolute value with the main flow direction.

By making opposed sections of at least one combustor wall non-parallel, e.g. such that they include a cone-like or wedge-like space, standing wave modes of the combustor in this region can be eliminated or moved to frequencies which do not couple with the flame, thereby decreasing sensitivity to combustion dynamics still further.

In an advantageous implementation of the inventive pre-mix combustion system, the system comprises a number of main mixing ducts, which form groups of main mixing ducts. Each group comprises at least a first main mixing duct and a second main mixing duct which each include a main air passage which leads to an outlet opening being open towards the combustion zone, and one or more fuel injection openings leading into the main air passage and connecting it to one or more main fuel supply passages so as to allow for the injection of main fuel into main air flowing through the main air passages. In each group of main mixing ducts the locations of the outlet openings of at least two main mixing ducts and the orientations of downstream sections of the main air passages of the main mixing ducts are chosen such that main fuel/air mixtures flowing out of the main mixing ducts show opposed flow paths so as to impinge on each other in an impingent zone of the combustion zone. The impingement zones of the groups of main mixing ducts are staggered in the combustion zone.

The staggering of the impact zones could, in particular, take place in the combustor axial direction, i.e. the main flow direction, to smear the heat released and reduce coupling with longitudinal modes of the combustion space. By suitable choice of main mixing duct numbers and stagger length of the impingement zones it might be possible to reduce the potential for coupling of the flame with circumferential modes of annular combustors.

In particular implementation of the invention, the pre-mix combustion system may comprise an annular combustor which has two opposing annular combustor walls. In this case, the first and second main mixing ducts may be formed as slots running at least partly around the annular combustor walls, in particular running around the whole circumference of the annular combustor. This could help to increase the flame stability and NOₓ suppression effects, and thereby enabling less piloting fuel to be used which further suppresses NOₓ formation.

It should be noted that there is no necessity in the inventive combustion method and system to restrict the mixing streams leading to a single impingement zone to two, or make them symmetrical. Furthermore, they do not have to impinge at 180° relative to each other or to be exactly in line axially. This opens up many degrees of freedom for the explicit design of flame-holding zones which have previously been unavailable to combustion engineers using state of the art swirl stabilised burners. Moreover, it is also conceivable to combine the inventive approach with a state of the art swirl burner, e.g. acting as the pilot burner, for the purpose of enhancing the flame straining behaviour of a low-pressure loss, bubble breakdown stabilised unit.

### BRIEF DESCRIPTION OF THE DRAWINGS

Further features, properties and advantages of the present invention will become clear from the following description of embodiments of the invention with reference to the accompanying drawings.

FIG. 1 shows a gas turbine engine in a sectional view.

FIG. 2 schematically shows a first embodiment of the inventive combustion system in a sectional view.

FIG. 3 schematically shows a second embodiment of the inventive combustion system in a sectional view.

FIG. 4 schematically shows a third embodiment of the inventive combustion system in a perspective view.

FIG. 5 shows a fourth embodiment of the inventive combustion system in a sectional view.

FIG. 6 shows a fifth embodiment of the inventive combustion system in a perspective view.

FIG. 7 schematically shows a sixth embodiment of the inventive combustion system in a sectional view.

FIG. 8 shows a seventh embodiment of the inventive combustion system in a sectional view.

FIG. 9 shows a modification of the embodiment illustrated in FIG. 4.

### DETAILED DESCRIPTION OF THE INVENTION

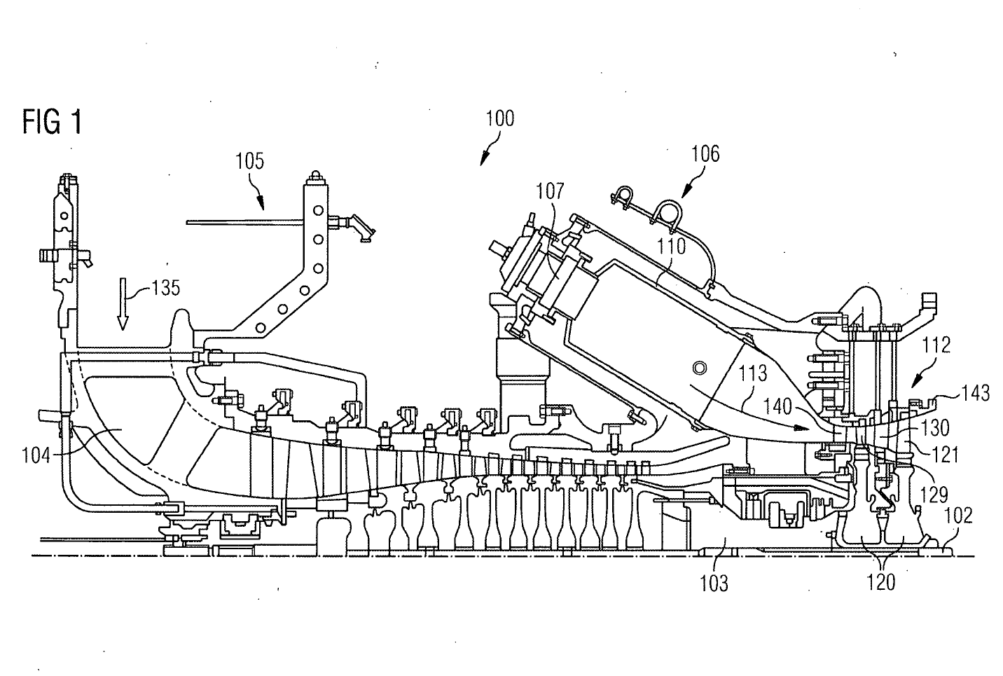

FIG. 1 shows an example of a gas turbine engine 100 in a sectional view. The gas turbine engine 100 comprises a compressor section 105, a combustor section 106 and a turbine section 112 which are arranged adjacent to each other in a longitudinal direction of a rotor axis 102. It further comprises a rotor 103 which is rotatable about the rotational axis 102 and which extends longitudinally through the gas turbine engine 100.

In operation of the gas turbine engine 100 air 135, which is taken in through an air inlet 104 of the compressor section 105, is compressed by the compressor section and output to the burner section 106. The burner section 106 comprises one or more combustion chambers 110 and at least one burner 107 fixed to each combustion chamber 110. The compressed air from the compressor exit 108 enters the burner 107 where it is mixed with a fuel, for example gas or oil. The air/fuel mixture is then burned and the exhaust gas 113 from the combustion is led through the combustion chamber 110 to the turbine section 112. A number of blade carrying discs 120 are fixed to the rotor 103 in the turbine section 112 of the engine. In the present example, two discs carrying turbine blades 121 are present. In addition, guiding vanes 130, which are fixed to a stator 143 of the gas turbine engine 100, are disposed between the turbine blades 121. Between the exit of the combustion chamber 110 and the leading turbine blades 121 inlet guiding vanes 140 are present. The exhaust gas from the combustion chamber 110 enters the turbine section 112 and, while flowing through the turbine section 112, transfers momentum to the turbine blades 121 which results in a rotation of the rotor 103. The guiding vanes 130, 140 serve to optimise the impact of the exhaust gas on the turbine blades 121.

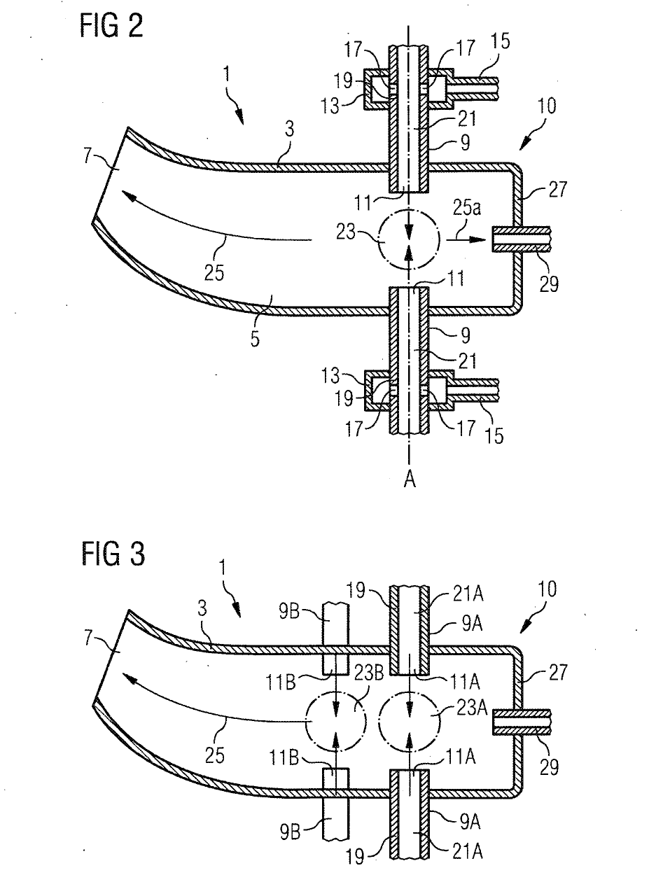

The combustion system which may be used in the gas turbine engine shown in FIG. 1 will now be described with respect to FIG. 2. The depicted combustion system comprises a combustor 1 with a combustor wall 3 surrounding an internal combustor space 5 which forms the combustion zone of the combustion system. An exit opening 7 is located in the combustor wall 3 at a downstream end of the internal combustor space 5.

Near the burner head end 10 of the combustor wall 3, which lies opposite the exit opening 7, two main mixing ducts 9 are arranged so as to extend partially into the internal combustor space 5. The main mixing ducts 9 form main air passages for guiding compressor air into the internal combustor space 5 through an outlet opening 11. A section of each mixing duct 9 is surrounded by a fuel gallery 13 which is fed through one or more fuel ducts 15. Injection holes 17, which are arranged in the mixing duct's walls 19 where they are surrounded by the fuel galleries 13, allow for the injection of main fuel into the main air flowing through the air passage 21.

The inventive burner system is a pre-mix burner system, i.e. main air and main fuel are mixed before being introduced into the combustion zone so as to form a main fuel/air mixture. The mixing takes place inside the mixing ducts 9. Since the mixing ducts 9 are centred around the same axis A and the outlet openings 11 of the mixing ducts 9 lie opposite each other, the streams of air mixture flowing out of the outlet openings 11 impinge on each other in an impingement zone 23. The air/fuel mixture is ignited by an igniter (not shown) and the resulting combustion flame extends in the flow direction 25 and also partially in the direction 25a. Once lit, the flame keeps burning without further assistance from the igniter.

The impingement zone 23 forms a stabilisation zone for the flame keeping it sufficiently far away from the combustor wall 3, so that only a small fraction of the wall surface area is exposed to hot re-circulating exhaust gas. Furthermore, a high stretch rate of the flame can be achieved without compromising mixing as the mixing takes place in the mixing ducts 9, i.e. before reaching the impingement zone 23, and therefore decouples from the stabilisation of the flame.

It shall be noted that swirl inducing elements could be located inside the mixing ducts 9 so as to induce a mixing swirl for mixing fuel and air. However, such mixing swirls have no flame stabilisation function like the swirl induced in the state of the art burners. The flame stabilisation is achieved by the impact of the main air/fuel mixtures impinging on each other in the impingement zone 23, only.

In the wall section 27 of the combustor wall's burner head end 10, which forms the upstream end of the combustor, a pilot burner 29 may be present. With this arrangement the impingement zone 23, i.e. the flame stabilisation zone, is directly accessible from the pilot burner 29 and it is possible to add a pilot fuel stream completely separate from the main fuel/air mixture streams which enhances design freedom to tailor fuel/air ratios and mixedness without reference to the main aerodynamics of the flame.

A second embodiment of the combustion system is shown in FIG. 3. The difference of the second embodiment to the first embodiment is the presence of two groups of main mixing ducts 9A, 9B which are staggered in flow direction 25 of the exhaust gas. Furthermore, they are also staggered in the direction which is perpendicular to the flow direction. The mixing ducts 9A, 9B themselves, as well as the combustor 1 do not differ from the mixing ducts 9 and combustor 1 in the first embodiment. They will therefore not be described in detail again.

By staggering the groups of mixing ducts 9A, 9B, staggered impingement zones 23A, 23B for the fuel/air mixtures flowing out of the outlet openings 11A, 11B are formed within the internal combustor space 5. By this measure, the heat release can be smeared and the coupling of the flame with longitudinal modes of the combustion space 5 can be reduced.

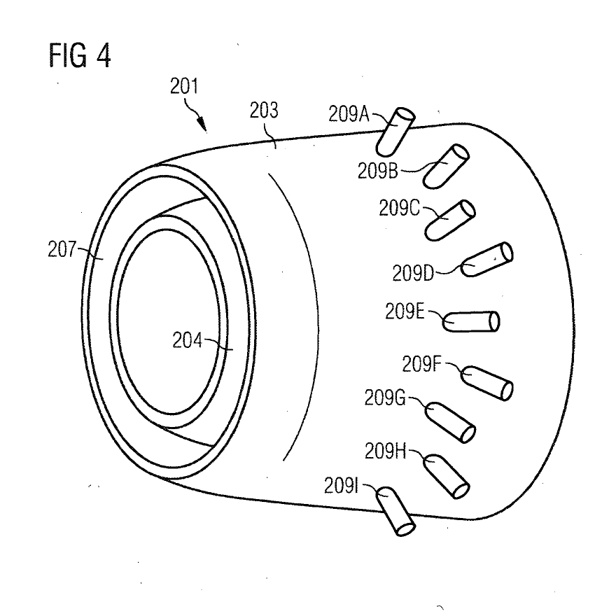

The staggering of the mixing ducts is particularly advantageous if used in an annular combustion system, as it is shown in FIG. 4 in a perspective view of a third embodiment of the invention. The figure shows the outer wall 203 and the inner wall 204 of an annular combustor 201 seen from its exit opening 207 side. The combustion system comprises a number of groups of mixing ducts indicated as 209A to 209I. Each group of mixing ducts comprises a first mixing duct and a second mixing duct which extend through the outer combustor wall 203 and the inner combustor wall 204, respectively. From each group of mixing ducts 209A to 209I only the mixing duct extending through the outer combustor wall 203 is visible in FIG. 4. The groups of mixing ducts 209A to 209I are staggered along the circumference of the combustor 201 as well as in a longitudinal direction of the combustor 201. By suitable choice of the number of groups of mixing ducts, the number of mixing ducts per group and the stagger lengths in both circumferential and longitudinal directions, the potential of the combustion flame for coupling with the circumferential modes of annular combustors can be reduced.

In the annular combustion system shown in FIG. 4, the mixing ducts 209A to 209I are in the form of pipes. However, it would also be possible to implement the mixing ducts as continuous slots 210 running around the circumference of an annular combustor 221, as is shown in FIG. 9.

A fourth embodiment of the inventive combustion system is shown in FIG. 5. The figure shows, as in FIG. 2, a section through the combustor 1 and the main mixing ducts 9. However, the section is perpendicular to the section of FIG. 2. This embodiment differs from the first embodiment, which is shown in FIG. 2, in that both main mixing ducts 9 are not centred about the same longitudinal axis. Instead, the axis A, A′ about which the mixing ducts 9 are centred are slightly offset with respect to each other. By this arrangement the axis A, A′ of the streaming paths of the fuel/air mixtures flowing out of the outlet openings 11 are slightly offset as well. However, the offset is small enough so that the streams of fuel/air mixture still impinge on each other in the impingement zone 23. Due to the small offset, a swirl is introduced into the flame. In other respects, the fourth embodiment does not differ from the first embodiment.

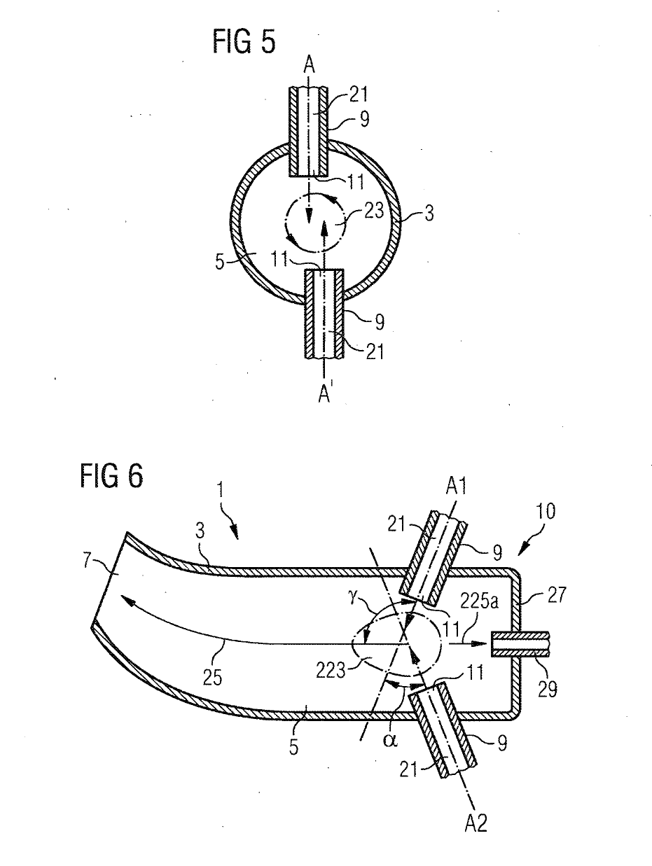

A fifth embodiment of the inventive combustion system is shown in FIG. 6. The fifth embodiment corresponds to the first embodiment, shown in FIG. 1, expect for the arrangement of the main mixing ducts 9 in the combustor wall 3. In contrast to the first embodiment the axes A1, A2 about which the main mixing ducts 9 are centred are not identical, and not even parallel to each other, as is the case in the fourth embodiment. Instead, they are inclined to each other by an inclination angle α. In the present embodiment the inclination angle is about 20°, however, it could be up to about 45°. As in the embodiment, the arrangement of the mixing ducts 9 in the combustor wall 3 is symmetrical, the inclination leads to an angle of the central axis A1, A2 of each mixing duct 9, with respect to the main flow direction 25 in the impingement zone 223, of about half the inclination angle α. In contrast to the embodiments shown so far, the flow direction of the fuel/air mixtures flowing out of the mixing ducts 9 is not perpendicular to the main flow direction 25 in the combustor 1. Furthermore, the impact zone 223 shows an asymmetry compared to the impact zones 23 of the embodiments described so far. By such an asymmetry the fraction of the fuel/air mixture flowing out of the impingement zone 223 in a direction 225a opposite to the main flow direction 25 can be reduced compared to the mixing duct arrangement shown in the embodiments so far.

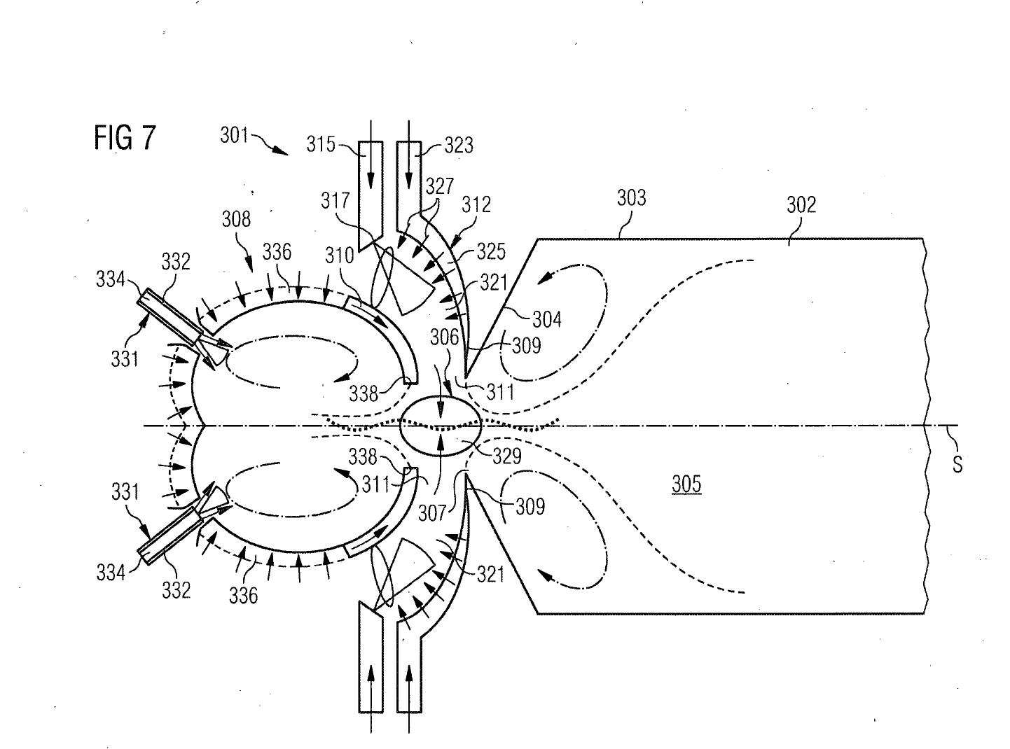

A sixth embodiment of the invention is shown in FIG. 7, which shows a longitudinal section through a combustion system. The combustion system of the sixth embodiment comprises a main combustion chamber 302 and a recirculation chamber 308 which is connected to the main combustion chamber 302 by a narrow connecting portion 306. The main combustion chamber 302, which has a larger diameter than the narrow connecting portion 306, merges with the narrow connecting portion 306 through a conically shaped dome portion 304. The whole assembly shows rotational symmetry about a symmetry axis S. The narrow connection portion, together with the internal combustor space 305, forms a combustion zone of the combustion system.

A single curved main mixing duct 309, which extends around the whole circumference of the narrow connecting portion 306, opens out to the connecting portion 306. The main mixing duct 309 is formed by the recirculation chamber's wall 310 and a mixing duct wall 312 which is located at a distance from the wall of the recirculation chamber 308 and which is fixed to the narrowest section of the dome portion 304 so as to encircle the dome portion's opening 307.

The space between the walls 310 and 312 forms a main air passage 321 into which a gaseous or liquid main fuel can be injected by means of injection openings 317 which are located in an upstream part of the air passage 321. The main fuel is led to the injection openings 317 through fuel conduits 315. Air is fed into the air passage 321 through air ducts 323 which merge with a hollow portion 325 of the mixing duct wall 312. The hollow portion 325, which has the shape of a curved wedge, is equipped with a number of openings which connect it to the main air passage 321.

Air fed from the air ducts 323 to the hollow portion 325 enters the air passage 321 through the openings 327. The air mixes with the injected fuel and, after flowing along a curved path, flows radially into the narrow connection portion 306. Hence, parts of the flow emerging from sections of the air passage 321 lie on opposed sections of the circumference of the narrow connecting portion 306. The fuel/air mixtures steaming out of the opposed sections flow towards the centre of the narrow connecting portion 306 where they impinge on each other under an angle of 180°. Therefore, a tube-like impingement zone 329 is formed in the narrow connecting portion 306. The impingement zone 329 stabilises the flame in the combustor.

After the impingement in the impingement zone 329, the fuel/air mixture flows out of the narrow connecting portion 306 along the symmetry axis S. While part of the fuel/air mixture flows into the main combustion chamber 302a certain part of the fuel/air mixture flows into the recirculation chamber 308. The geometry of the recirculation chamber 308 is chosen such that the fuel/air mixture flowing into the recirculation chamber 308 recirculates into the impingement zone 329. This recirculation of the fuel/air mixture into the impingement zone 329 leads to the so-called reburn phenomenon which reduces NOₓ emissions.

In the present embodiment, additional or supplemental, fuel and additional or supplemental air are introduced into the fuel/air mixture recirculating in the recirculation chamber 308. For this purpose, fuel ducts 331 lead into the recirculation chamber 308. The walls 332 of the fuel ducts 331 are hollow and enclose a fuel passage 334. While fuel is injected into the recirculation chamber 308 through the fuel passages 334, air is introduced into the recirculation chamber 308 through the hollow walls 332 of the fuel ducts 331. This leads to an envelope of isolating air around the injected fuel. Furthermore, cooling channels are present in the wall 310 of the recirculation chamber 308. These cooling channels open towards the narrow connecting portion 306. However, the orientation of the outlet openings 338 of the cooling channels 336 and the curvature of the cooling channels just before the outlet openings 338 are chosen such that the cooling air which is introduced into the recirculation chamber 308 mainly flows into the recirculation chamber 308. If at all, only a minor part of the cooling air from the recirculation chamber's wall 310 flows into the impingement zone 329.

The fuel/air mixture flowing into the re-circulation chamber 308 is partly burned when it flows out of the impingement zone 329. It therefore forms a flue gas. By introducing additional fuel and additional air into the flue gas recirculating in the recirculation chamber 308, it becomes possible to reburn the flue gas so that a flue gas diluted combustion can be realised which leads to lower NOₓ emissions compared to conventional combustion. The described flue gas recirculation also strongly enhances flame stability and may help in controlling acoustic pulsations in the flame.

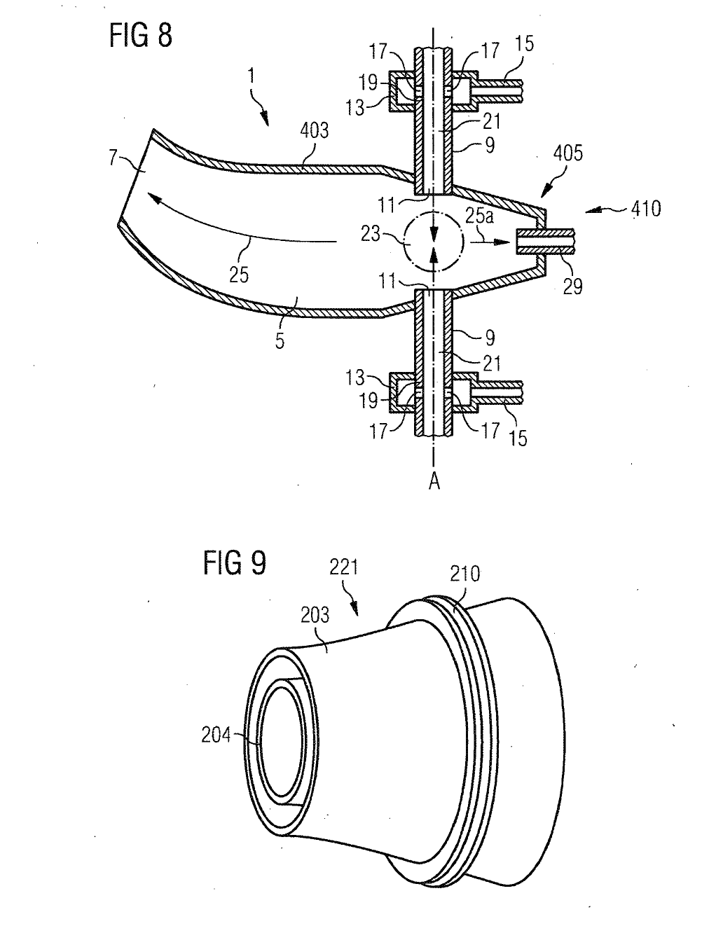

A seventh embodiment of the inventive combustion system is shown in FIG. 8. This figure shows a section which corresponds to the section shown in FIG. 2. The combustion system of the seventh embodiment corresponds to the first embodiment, shown in FIG. 2, except for the shape of the combustor wall 403. The combustor wall 403 of the seventh embodiment comprises wedge-like shaped wall sections 427 at the burner head end 410. The impingement zone 23 is located between the wedge-like shaped wall sections 427. This design of a combustor wall 403 helps to reduce standing wave modes in the impingement zone parallel and perpendicular to the stabilisation. The standing wave modes will either be eliminated or moved to frequencies which do not couple with the fuel/air mixture supply, thereby decreasing the sensitivity of the combustion system to combustion dynamics.

All embodiments described herein realise a new burner concept in which the pre-mixing of main fuel and main air can be decoupled from the flame stabilisation. With the new burner concept a good flame stabilisation can be achieved while, at the same time, NOₓ emissions can be reduced.

1.-15. (canceled)

16. A method for operating a gas turbine pre-mix combustion system, comprising:
mixing a fuel with air for generating a main fuel/air mixture;
introducing a plurality of streams of the main fuel/air mixture into a combustion zone;
grouping the streams into a plurality of groups of streams;
impinging at east two of the streams in the groups of streams on each other in impingement zones by introducing the at east two of the streams in opposed flow paths; and
staging the impingement zones of the groups of streams in the combustion zone in a flow direction of an exhaust gas and in a direction perpendicular to the flow direction.

17. The method as claimed in claim 16, wherein the streams of the main fuel/air mixture are introduced into the combustion zone for impinging on each other off-centre.

18. The method as claimed in claim 16, wherein the streams of the main fuel/air mixture are introduced with an angle of at least 45° with respect to a main flow direction of the main fuel/air mixture in the combustion zone.

19. The method as claimed in claim 16, wherein a fraction of the main fuel/air mixture that is not flowing in a main flow direction of the fuel/air mixture in the combustion zone is re-circulated into the combustion zone.

20. The method as claimed in claim 19, wherein an additional fuel or air is introduced into the re-circulated main fuel/air mixture.

21. A pre-mix combustion system for a gas turbine, comprising
a combustor with a combustor wall that partly surrounds a combustion zone and a plurality of groups of main mixing ducts;
main air passages in the main mixing ducts which lead to outlet openings being open towards the combustion zone; and
fuel injection openings that lead into the main air passages and connect the main air passages to a main fuel supply passage to inject a main fuel into main air flowing through the main air passages to generate a main fuel/air mixture,
wherein locations of the outlet openings and orientations of downstream sections of the main air passages of at least two of the main mixing ducts in each of the groups are chosen such that flow paths of the main fuel/air mixture of the at least two of the main mixing ducts flowing out of the outlet openings have opposed flow paths to impinge on each other in impingement zones of the combustion zone, and
wherein the impingement zones of the groups of the main mixing ducts are staggered in the combustion zone in flow direction of an exhaust gas and in an direction perpendicular to the flow direction.

22. The pre-mix combustion system as claimed in claim 21, wherein the locations of the outlet openings and the orientations of the downstream sections are chosen such that the flow paths are offset relative to each other so that the impingement is off-centre.

23. The pre-mix combustion system as claimed in claim 21, wherein the downstream sections of the main air passage or the main air passages are curved.

24. The pre-mix combustion system as claimed in claim 21, wherein the locations of the outlet openings and the orientations of the downstream sections are chosen such that the flow paths comprise an angle of at least 90° with respect to a main flow direction in the combustor.

25. The pre-mix combustion system as claimed in claim 24, wherein the locations of the outlet openings and the orientations of the downstream sections are symmetric with respect to the main flow direction.

26. The pre-mix combustion system as claimed in claim 21, wherein an opposing section of the combustor wall is non-parallel.

27. The pre-mix combustion system as claimed in claim 26, wherein the opposing section of the combustor wall has a cone-like or wedge-like shape.

28. The pre-mix combustion system as claimed in claim 21, wherein a recirculation zone is formed at an upstream end of the combustion zone.

29. The pre-mix combustion system as claimed in claim 21, wherein the impingement zones are staggered in a main flow direction of the combustor.

30. The pre-mix combustion system as claimed in claim 21, wherein the combustor is an annular combustor with two opposing annular combustor walls and the main mixing ducts are slots running at least partly around the annular combustor walls.
